(19) United States
(12) Patent Application Publication
(10) Pub. No.: US 2007/0292033 A1
(43) Pub. Date: Dec. 20, 2007

(54) Passive and interactive real-time image recognition software method

(76) Inventors: Chao-Wang Hsiung, Taipei City (TW); Chih Hung Chuang, Taipei City (TW); Hsien-Wen Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/455,187

(22) Filed: Jun. 19, 2006

(51) Int. Cl. G06K 9/68

(52) U.S. Cl. 382/218

(57) ABSTRACT

This invention relates to a passive and interactive real-time image recognition software method, particularly to a real-time image recognition software method without the effects of the ambient light sources and noises, which includes passive and interactive recognition methods.

### BACKGROUND OF THE INVENTION

1. Field of the Invention

This invention relates to a passive and interactive real-time image recognition software method, particularly to a real-time image recognition software method without the effects of the ambient light sources and noises, which includes passive and interactive recognition methods.

2. Description of the Related Art

According to the current real-time image recognition technology, multimedia moving images are mostly projected by an LCD projector (or other image display devices), and the obtained images are digitized through a video camera and image capture interface.

By using related recognition technology, areas touched by the human body can be detected and recognized and can be responded to accordingly. A prior recognition technology discussed in U.S. Pat. No. 5,534,917 applies to an AND operation to recognize patterns, which primarily uses the pattern in the image area as a template to store and then picks these images from a video camera for identification. The identification processes are checked one by one. Although such recognition method is simple and does not require a high operation speed, it is subject to the influence of various background lights and results in recognition errors. However, the hue saturation of pattern templates previously stored in the memory is changed after the projection. Furthermore, the system is mounted at different occasions which make the background illuminant different. Therefore, if the recognition technology is used, the color temperature and chromatic aberration must be calibrated after the system has been created. This process is very complicated.

Accordingly, to solve the above-mentioned problems, the present invention has been made to provide a recognition software method without impacts from the change of ambient light sources and color differences caused by images projected by an image projection apparatus, wherein a grey-scale video is used so that data transit becomes less and the cost of hardware apparatus can be largely reduced.

The objects, features, structure, and principles of the present invention will be more apparent from the following detailed descriptions.

### SUMMARY OF THE INVENTION

The present invention relates to a passive and interactive real-time image recognition software method, particularly to a real-time image recognition software method without the influence of ambient light sources and noises, which includes passive and interactive recognition methods. Such method uses an image projection apparatus to project the images for building a (8-bits grey level) fixed background image as a reference image, and continuously collects the real-time images (8-bits of grey-level value) and reference images from the image area projected by the image projection apparatus using a video camera to proceed operations such as image differentiation and binarization. The activities of a moving object then can be identified quickly and accurately to check if the reactive area of the projected image is blocked. Then, the corresponding action will be performed accordingly.

Furthermore, since the present invention employs a grey-scale video to capture images, it is unnecessary to use a high-end image acquisition board or various high unit-price hardware as auxiliaries and only a typical computer is needed to perform recognition accurately. Therefore, the cost can be largely reduced. Accordingly, the real-time image recognition software method of the present invention is provided for a variety of applications such as multimedia interactive advertisements, learning and instruction, games and video games.

### BRIEF DESCRIPTION OF THE DRAWING

FIG. 1 is a schematic view showing the system architecture of the passive and interactive real-time image recognition software method in the present invention;

FIG. 2 is a diagram showing the reference image pre-captured by a video camera according to the passive and interactive real-time image recognition software method in the present invention;

FIG. 3 is a diagram showing the real-time image captured by a video camera according to the passive and interactive real-time image recognition software method in the present invention;

FIG. 4 is a diagram showing the differentiation of the acquired reference images and real-time images according to the passive and interactive real-time image recognition software method in the present invention;

FIG. 5 is a diagram showing the optimal threshold as the grey-level value in the wave trough position according to the passive and interactive real-time image recognition software method in the present invention;

FIG. 6 is a diagram showing the areas between two optimal thresholds according to the passive and interactive real-time image recognition software method in the present invention;

FIG. 7 is a diagram showing the reference images and real-time images being differentiated and then binarized according to the passive and interactive real-time image recognition software method in the present invention;

FIG. 8 is a diagram showing the four connected masks in the passive and interactive real-time image recognition software method of the present invention;

FIG. 9 is a diagram showing the Sobel mask (a) axis x and (b) axis y in the passive and interactive real-time image recognition software method of the present invention;

FIG. 10 is a diagram showing the interactive reference image in the passive and interactive real-time image recognition software method of the present invention;

FIG. 11 is a diagram showing the interactive real-time image in the passive and interactive real-time image recognition software method of the present invention;

FIG. 12 is a diagram showing the interactive reference image and real-time image being differentiated and then binarized according to the passive and interactive real-time image recognition software method in the present invention;

FIG. 13 is a diagram showing the interactive objective line segment coding section in the passive and interactive real-time image recognition software method of the present invention;

FIG. 14 is a diagram showing the interactive activity image and activity reactive area being segmented according to the passive and interactive real-time image recognition software method in the present invention;

FIG. 15 is a diagram showing the recognition results of the interactive activity reactive area according to the passive and interactive real-time image recognition software method in the present invention.

### DETAILED DESCRIPTION OF THE INVENTION

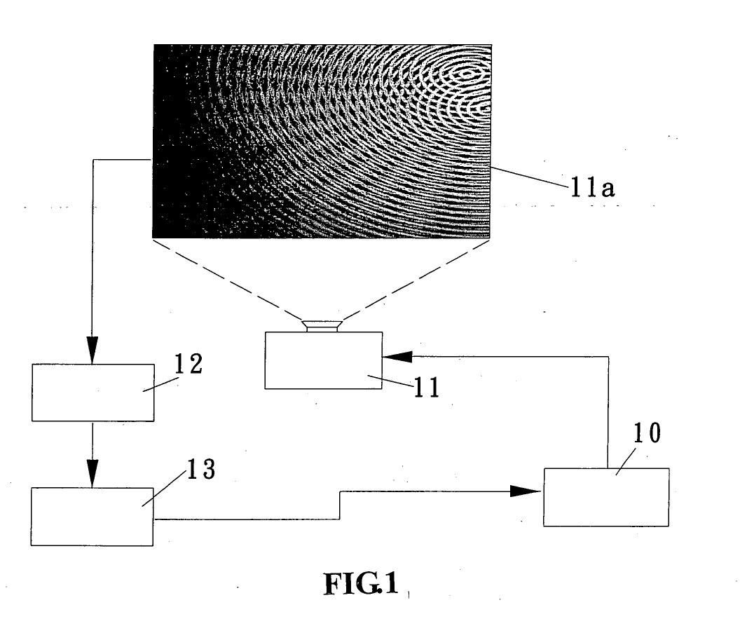

FIG. 1 is a schematic view showing the system architecture of the passive and interactive real-time image recognition software method in the present invention. As shown in the figure, the method includes a personal computer 10, an image projection apparatus 11, image areas 11a, a video camera 12 and an image acquisition board 13.

The present invention is a passive and interactive real-time image recognition software method, which can be divided into passive and interactive method depending on the type of identification object. The difference between passive and interactive is on the position of said activity reactive area. In the passive identification module, the position of activity reactive area is fixed; the interactive one is the opposite, the activity reactive area varies in a range on the projected image area projected by the image projection apparatus.

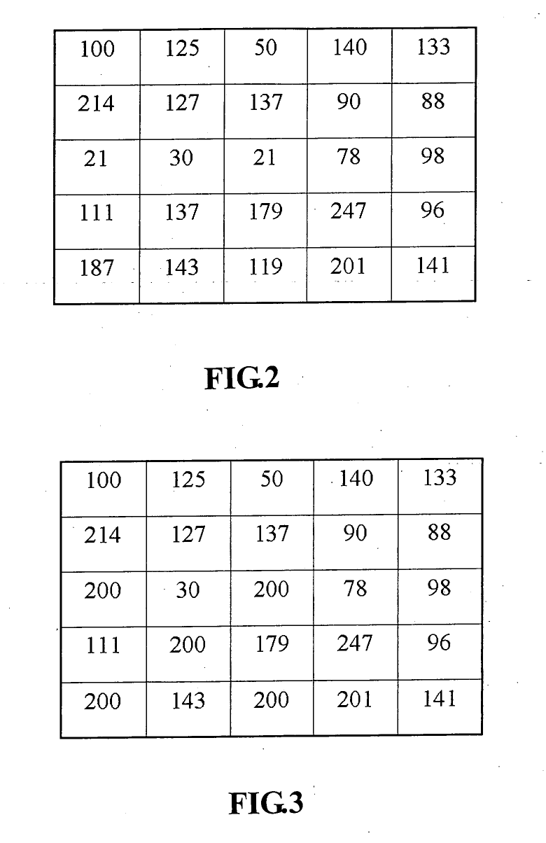

Further, the acquired images in the present invention are all 8 bit grey level. The grey-level value ranges from 0 to 225.

Whereas, the passive real-time image recognition method is described as follows:
Step 1: Capture an image projected by an image projection apparatus 11 to image areas 11a as reference images (5×5 grey-level value) (referring to FIGS. 1 and 2) by using a video camera 12;
Step 2: Continuously capture real-time images (5×5 grey-level value) projected by an image projection apparatus 11 to image areas 11a referring to FIGS. 1 and 3) by using a video camera 12, and check if any foreign object touches the reactive area.

The difference value between the reference image from step 1 (referring to FIG. 2) and the real-time image from step 2 (referring to FIG. 3) can be denoted as follows:

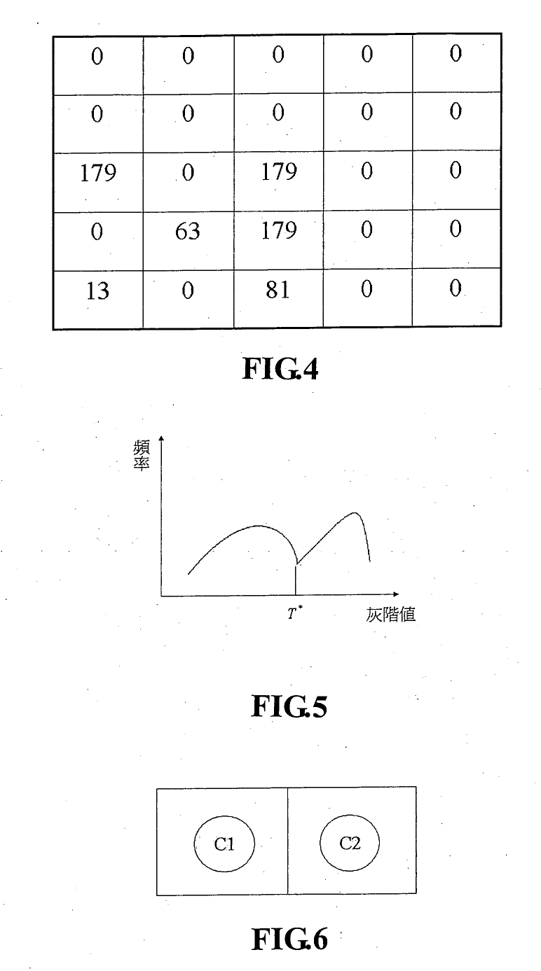

DIFF(x,y)=|REF(x,y)−NEW(x,y)| (1)
Step 3: Difference of the grey-level value of real-time image in step 2 and the grey-level value of reference image in step 1 to have the grey-level distribution of remaining images (referring to FIG. 4, which means foreign objects exist.
Step 4: The image which is subject to differencing through step 3 usually has noises, which can be present as in formula (2)

$$BIN ( x , y ) = \{ \begin{matrix}255 & DIFF ( x , y ) \geq {T}^{*} \\ 0 & DIFF ( x , y ) < {T}^{*}\end{matrix} \qquad ( 2 )$$

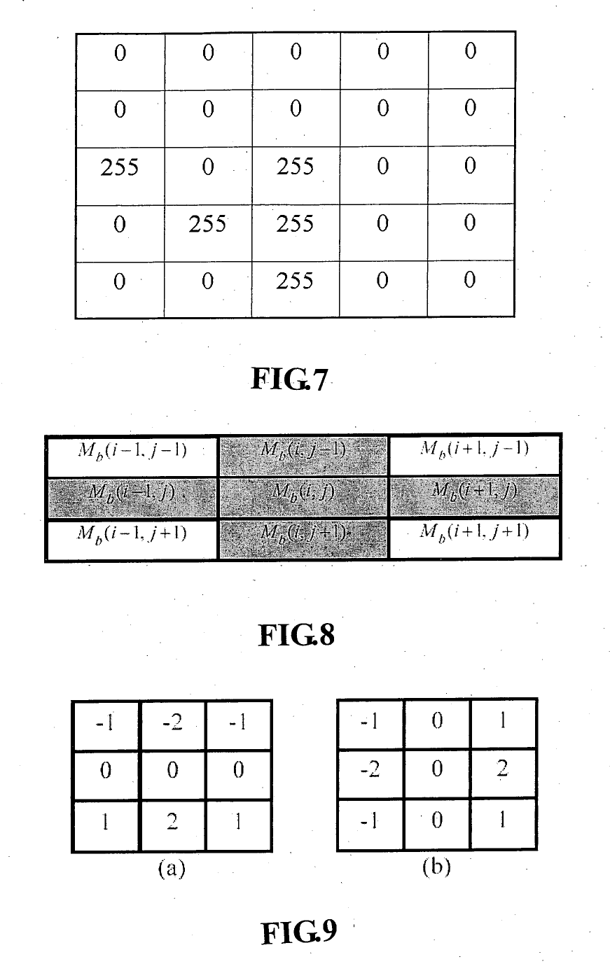

The binarization method eliminates the noises (referring to FIG. 7); in which, T* represents a threshold, in 8 bit grey-scale image and the threshold ranges from 0 to 255. The optimal threshold can be decided by a statistical method. The optimal threshold is on the wave trough of the grey-level value (referring to FIG. 5); when T* is decided, the image can be segmented into two sections (referring to FIG. 6). The requirement for the optimal threshold T* is when the sum of variances in C₁ and the variances in C₂ has the minimum value. It is assumed that the size of the image is N=5×5, and the grey-level value number of 8 bit grey-level image is I=256. Then the probability of grey-level value is I can be denoted as:

$$P ( i ) = \frac{{n}_{i}}{N} \qquad ( 3 )$$

Wherein nᵢ indicates the appearance number of grey-level value I, and the range of I is 0≦i≦I−1. According to the probability principle, the following can be obtained:

$${\sum }_{i = 0}^{I - 1} P ( i ) = 1 \qquad ( 4 )$$

Suppose the ratio of the pixel number in C₁ is:

$${W}_{1} = Pr ( {C}_{1} ) = {\sum }_{i = 0}^{{T}^{*}} P ( i ) \qquad ( 5 )$$

While the ratio of the pixel number in C₂ is:

$${W}_{2} = Pr ( {C}_{2} ) = {\sum }_{i = {T}^{*} + 1}^{I - 1} P ( i ) \qquad ( 6 )$$

Here W₁+W₂=1 can be satisfied.

The expect value of C₁ can be calculated as:

$${U}_{1} = {\sum }_{i = 0}^{{T}^{*}} \frac{P ( i )}{{W}_{1}} \times i \qquad ( 7 )$$

The expect value of C₂ is:

$${U}_{2} = {\sum }_{i = {T}^{*} + 1}^{I - 1} \frac{P ( i )}{{W}_{2}} \times i \qquad ( 8 )$$

The variance of C₁ and C₂ can be obtained by using the formula (7) and (8).

$$\begin{matrix}{σ}_{1}^{2} = {\sum }_{i = 0}^{{T}^{*}} {( i - {U}_{1} )}^{2} \frac{P ( i )}{{W}_{1}} & ( 9 ) \\ {σ}_{2}^{2} = {\sum }_{i = {T}^{*} + 1}^{I - 1} {( i - {U}_{2} )}^{2} \frac{P ( i )}{{W}_{2}} & ( 10 )\end{matrix}$$

The sum of variance in C₁ and C₂ are:

σ₂²=W₁σ₁²+W₂σ₂² (11)

### Substitute the value 0˜255 for formula (11). When the formula (11) has the minimum value, then the optimal threshold T* can be obtained.

Step 5: Although the residual noises have been removed through binarization in step 4, however, the moving object becomes dilapidated. This can be removed by using four connected masks (referring to FIG. 8) and the inflation and erosion algorithm. The inflation algorithm is described as follows: when M_{b}(i,j)=255, set the mask of the 4-neighbor points as

M_{b}(i,j−1)=M_{b}(i,j+1)=M_{b}(i−1,j)=M_{b}(i+1,j)=255 (12)

The erosion algorithm is described as follows:

when M_{b}(i,j)=0, set the mask of the 4 neighbor points as

M_{b}(i,j−1)=M_{b}(i,j+1)=M_{b}(i−1,j)=M_{b}(i+1,j)=0 (13)

Convoluting the above-mentioned mask and binarized image can eliminate the dilapidation.
Step 6: Next, the lateral mask can be used to obtain the contours of the moving object. Where, the Sobel (the image contour operation mask) (referring to FIG. 9) is used to obtain the object contours. Convolute the Sobel (the image contour operation mask) mask and the real-time image, which can be denoted by formula (14) and (15):

Gₓ(x,y)=(NEW(x−1,y+1)+2×NEW(x,y+1)+NEW(x+1,y+1))−(NEW(x−1,y−1)+2×NEW(x,y−1)+NEW(x+1,y−1)) (14)

G_{y}(i,j)=(NEW(x+1,y−1)+2×NEW(x+1,y)+NEW(x+1,y+1))−(NEW(x−1,y−1)+2×NEW(x−1,y)+NEW(x−1,y+1)) (15)

### The rim of the acquired image can be obtained by using formula (16).

G(x,y)=\sqrt{Gₓ(x,y)²+G_{y}(x,y)²} (16)

### Then the above rim image is binarized.

$$E ( x , y ) = \{ \begin{matrix}255 & G ( x , y ) \geq {T}_{e}^{*} \\ 0 & G ( x , y ) < {T}_{e}^{*}\end{matrix} \qquad ( 17 )$$

Wherein Tₑ* represents the optimal threshold, the optimal threshold can be obtained using the prior method; then, after mixing the binarization contour pattern of the real-time image and the differentiated binary image BIN(x,y), the periphery contour of the moving object can be obtained.
Step 7: Check if the contour point coordinates of the moving object is touched by the reactive area and run the corresponding movement.
Step 8: Repeat all the steps above.

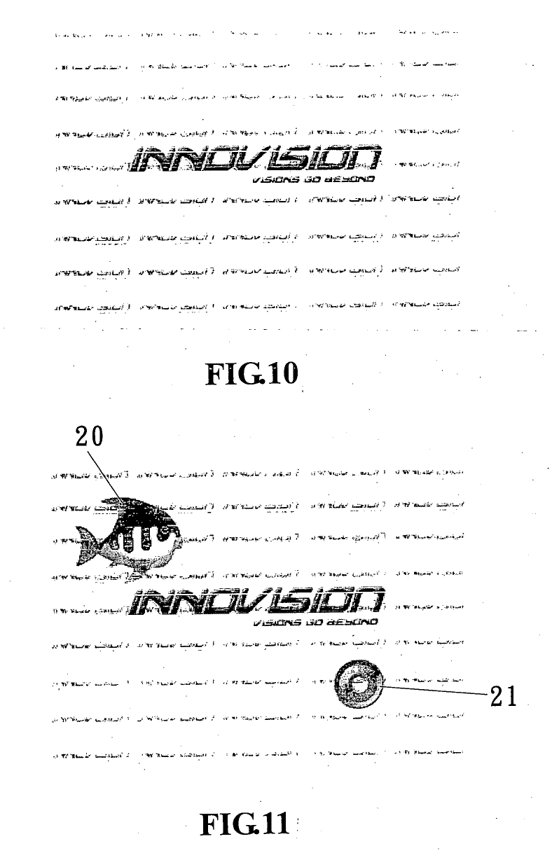

Other steps of the interactive real-time image recognition software method are image differentiation, binarization, image segmentation, reactive area pattern characteristic acquisition and reactive area pattern recognition where reactive area pattern characteristic acquisition is off-line obtained in advance and the reactive area pattern recognition uses the real-time process. Since the projected images in the reactive area can be any shape and have rotation or shifting movement, the pattern characteristic value cannot be influenced by rotating, shifting, shrinking or magnifying. The pattern characteristic value adapted here is the unchanged matrix of the pattern to be identified. It will not be affected by any shifting, rotating and size change. The said interactive real-time image recognition software method is described as follows:
Step 1: Capture the image projected to the image region 11a by an image projection apparatus 11 as reference images (referring to FIGS. 1 and 10) by using video camera 12;
Step 2: Capture the real-time image (referring to FIG. 11) continuously projected by an image projection apparatus 11 to the image region 11a by using a video camera 12, wherein images have active images 20. Then, check if the reactive area 21 is touched by any foreign object.

The difference value between reference images in step I(referring to FIG. 10) and real-time images in step 2 (referring to FIG. 11). can be defined by the following formula:

DIFF(x,y)=|REF(x,y)−NEW(x,y)| (1)
Step 3: Difference of the grey-level values of said reference image (referring to FIG. 10) from step 1 with grey-level values of real-time images (referring to FIG. 11) from step 2 and get the remaining image, which is denoted by formula (2)

$$BIN ( x , y ) = \{ \begin{matrix}255 & DIFF ( x , y ) \geq {T}^{*} \\ 0 & DIFF ( x , y ) < {T}^{*}\end{matrix} \qquad ( 2 )$$

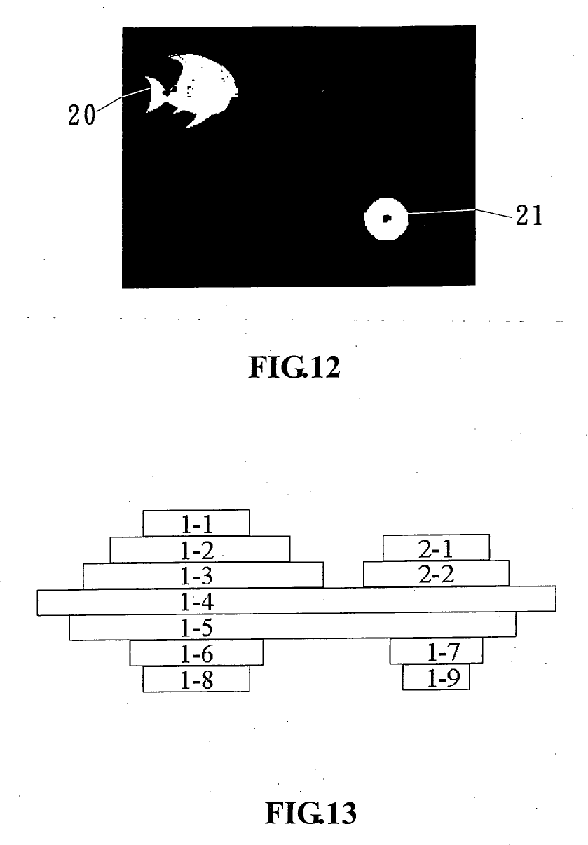

### The binarization method removes the effect of noises (Referring to FIG. 12).

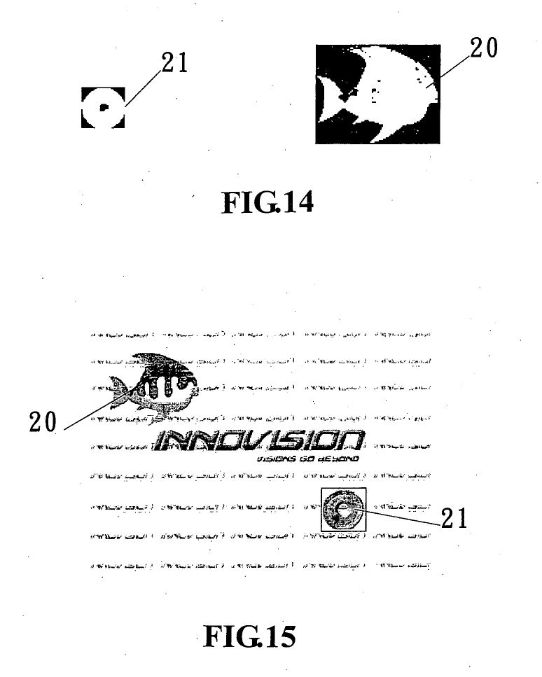

Step 4: After binarization, the white segments (referring to FIG. 12) refer to the active images 20 and 21 within the images. The active images 20 and 21 can be segmented by using the Line Segment Coding Method (referring to FIG. 14), said line segment coding method (referring to FIG. 13) is a line segment restore method to store every bit of data in an object. Once the segmented images are detected in line 1, it can be regarded as the first line of the first object denoted as 1-1. Then, two lines are detected in the second line. Since the first line is under 1-1 that is denoted as 1-2, the second line is a new object denoted as 2-1. Accordingly, there is only 1 line under object 1 and object 2 in the forth line. Therefore, the image originally regarded as two objects actually is an object, which is denoted as 1-4. After all the images are scanned, then the merge procedure is performed.

Wherein, the information of every object includes: square area, circumference, object characteristic, segmented image size, width and the total number of the object.
Step 5: When the active images 20 and activity reactive area 21 are segmented, every object characteristic value is calculated. Seven unchanged matrixes are used to represent the object characteristics. The solution is described as follows:

The (k+1) matrix definition of a binary image b(m,n) is

$${M}_{k , l} = {\sum }_{m = 0}^{M - 1} {\sum }_{n = 0}^{N - 1} {m}^{k} {n}^{l} b ( m , n ) \qquad ( 18 )$$

Wherein, the center matrix is defined as:

$${μ}_{k , l} = {\sum }_{m = 0}^{M - 1} {\sum }_{n = 0}^{N - 1} {( m - \overline{x} )}^{k} {( n - \overline{y} )}^{l} b ( m , n ) \qquad ( 19 )$$

Wherein,

$$\overline{x} = \frac{{M}_{1 , 0}}{{M}_{0 , 0}} , \overline{y} = \frac{{M}_{0 , 1}}{{M}_{0 , 0}}$$

represents the mass center of the object respectively.

Then the normalized center matrix of the formula (19) is defined as follows:

$${η}_{k , l} = \frac{{μ}_{k , l}}{{( \sqrt{{μ}_{0 , 0}} )}^{k + l + 2}} \qquad ( 20 )$$

The seven unchanged matrixes can be obtained by the normalized second and third order matrix:

$${φ}_{1} = {η}_{2 , 0} + {η}_{0 , 2}$$

$${φ}_{2} = {( {η}_{2 , 0} - {η}_{0 , 2} )}^{2} + 4 {η}_{1 , 1}^{2}$$

$${φ}_{3} = {( {η}_{3 , 0} - 3 {η}_{1 , 2} )}^{2} + {( 3 {η}_{2 , 1} - {η}_{0 , 3} )}^{2}$$

$${φ}_{4} = {( {η}_{3 , 0} + {η}_{1 , 2} )}^{2} + {( {η}_{2 , 1} + {η}_{0 , 3} )}^{2}$$

$$\begin{matrix}{φ}_{5} = ( {η}_{3 , 0} - 3 {η}_{1 , 2} ) ( {η}_{3 , 0} + {η}_{1 , 2} ) [ {( {η}_{3 , 0} + {η}_{1 , 2} )}^{2} - 3 {( {η}_{2 , 1} + {η}_{0 , 3} )}^{2} ] + \\ ( 3 {η}_{2 , 1} - {η}_{0 , 3} ) ( {η}_{2.1} + {η}_{0 , 3} ) [ 3 {( {η}_{3 , 0} + {η}_{1 , 2} )}^{2} - {( {η}_{2 , 1} + {η}_{0 , 3} )}^{2} ]\end{matrix}$$

$$\begin{matrix}{φ}_{6} = ( {η}_{2 , 0} - {η}_{0 , 2} ) [ {( {η}_{3 , 0} + {η}_{1 , 2} )}^{2} - {( {η}_{2 , 1} + {η}_{0 , 3} )}^{2} ] + \\ 4 {η}_{1 , 1} ( {η}_{3 , 0} + {η}_{1 , 2} ) ( {η}_{2 , 1} + {η}_{0 , 3} )\end{matrix}$$

$$\begin{matrix}{φ}_{7} = ( 3 {η}_{2 , 1} - {η}_{0 , 3} ) ( {η}_{3 , 0} + {η}_{1 , 2} ) [ {( {η}_{3 , 0} + {η}_{1 , 2} )}^{2} - 3 {( {η}_{2 , 1} + {η}_{0 , 3} )}^{2} ] + \\ ( 3 {η}_{1 , 2} - {η}_{0 , 3} ) ( {η}_{2 , 1} + {η}_{0 , 3} ) [ 3 {( {η}_{3 , 0} + {η}_{1 , 2} )}^{2} - {( {η}_{2 , 1} + {μ}_{0 , 3} )}^{2} ]\end{matrix}$$

Step 6: In the realistic pattern recognition process, the pattern of each category has different characteristic vectors within a range, while the falling point within the range cannot be predicted precisely even the range is known. Such kind of random problem can be described using the probability concept. Here, the Bayesian classifier of Gaussian pattern category is adopted to recognize patterns to be identified in real time, which can be described as:

$${D}_{j} ( x ) = - \frac{1}{2} ln \vert {C}_{j} \vert - \frac{1}{2} [ {( x - {m}_{j} )}^{T} {C}_{j}^{- 1} ( x - {m}_{j} ) ] , \\ j = 1 , 2 Λ M - \qquad ( 21 )$$

Wherein, Dⱼ is the j^{th} pattern decision function; x=[φ₁Aφ₇] is the jth eigenvector; mⱼ and Cⱼ is the j^{th} average eigenvector and covariance matrix. When D is the maximum, it is classified as the j^{th} pattern. After the pattern recognition is completed, the position of the reactive area is decided. If there are several reactive areas 21 in the images, there are several sub reference images. The passive recognition step 1 through 8 are utilized to determine whether the foreign object touches the sub reference images. The recognition process can be summarized as:
(1). Practice the pattern template in advance, calculate each category φ₁Aφ₇, and calculate mⱼ and Cⱼ of each category, then the decision rules of each categorizer are completed.
(2). Segment the images acquired by video camera 12 into several sub images through step 4, and then calculate each Dⱼ (x) of sub images.
(3). Compare the size of Dⱼ (x), identify the maximum, and set the pattern as the k^{th} category.
After the recognition, the activity reactive area 21 can be located precisely (referring to FIG. 15).
Step 7: Check if the activity reactive area 21 is touched by foreign objects and perform the corresponding actions.
Step 8: Repeat all the steps above.

What is claimed is:

1. Whereas, the passive real-time image recognition method is described as follows:
Step 1: Capture an image projected by an image projection apparatus to image areas as reference images (5×5 grey-level value) by using a video camera;
Step 2: Continuously capture real-time images (5×5 grey-level value) projected by an image projection apparatus to image areas by using a video camera, and check if any foreign object touches the reactive area.
The difference value between the reference image from step 1 and the real-time image from step 2 can be denoted as follows (1):
DIFF(x,y)=|REF(x,y)−NEW(x,y)| (1)
Step 3: Difference of the grey-level value of real-time image in step 2 and the grey-level value of reference image in step 1 to have the grey-level distribution of remaining images, which means foreign objects exist.
Step 4: The image which is subject to differencing through step 3 usually has noises, which can be present as in formula (2)
$$BIN ( x , y ) = \{ \begin{matrix}255 & DIFF ( x , y ) \geq {T}^{*} \\ 0 & DIFF ( x , y ) < {T}^{*}\end{matrix} \qquad ( 2 )$$
The binarization method eliminates the noises; in which, T* represents a threshold, in 8 bit grey-scale image and the threshold ranges from 0 to 255. The optimal threshold can be decided by a statistical method. The optimal threshold is on the wave trough of the grey-level value; when T* is decided, the image can be segmented into two sections. The requirement for the optimal threshold T* is when the sum of variances in C₁ and the variances in C₂ has the minimum value. It is assumed that the size of the image is N=5×5, and the grey-level value number of 8 bit grey-level image is I=256. Then the probability of grey-level value is I can be denoted as:
$$P ( i ) = \frac{{n}_{i}}{N} \qquad ( 3 )$$
Wherein nᵢ indicates the appearance number of grey-level value I, and the range of I is 0≦i≦I−1. According to the probability principle, the following can be obtained:
$${\sum }_{i = 0}^{I - 1} P ( i ) = 1 \qquad ( 4 )$$
Suppose the ratio of the pixel number in C₁ is:
$${W}_{1} = Pr ( {C}_{1} ) = {\sum }_{i = 0}^{{T}^{*}} P ( i ) \qquad ( 5 )$$
While the ratio of the pixel number in C₂ is:
$${W}_{2} = Pr ( {C}_{2} ) = {\sum }_{i = {T}^{*} + 1}^{I - 1} P ( i ) \qquad ( 6 )$$
Here W₁+W₂=1 can be satisfied.
The expect value of C₁ can be calculated as:
$${U}_{1} = {\sum }_{i = 0}^{{T}^{*}} \frac{P ( i )}{{W}_{1}} \times i \qquad ( 7 )$$
The expect value of C₂ is:
$${U}_{2} = {\sum }_{i = {T}^{*} + 1}^{I - 1} \frac{P ( i )}{{W}_{2}} \times i \qquad ( 8 )$$
The variance of C₁ and C₂ can be obtained by using the formula (7) and (8).
$$\begin{matrix}{σ}_{1}^{2} = {\sum }_{i = 0}^{{T}^{*}} {( i - {U}_{1} )}^{2} \frac{P ( i )}{{W}_{1}} & ( 9 ) \\ {σ}_{2}^{2} = {\sum }_{i = {T}^{*} + 1}^{I - 1} {( i - {U}_{2} )}^{2} \frac{P ( i )}{{W}_{2}} & ( 10 )\end{matrix}$$
The sum of variance in C₁ and C₂ are:
σ_{w}²=W₁σ₁²+W₂σ₂² (11)
Substitute the value 0-255 for formula (11). When the formula (11) has the minimum value, then the optimal threshold T* can be obtained.
Step 5: Although the residual noises have been removed through binarization in step 4, however, the moving object becomes dilapidated. This can be removed by using four connected masks and the inflation and erosion algorithm.
The inflation algorithm is described as follows: when M_{b}(i,j)=255, set the mask of the 4-neighbor points as
M_{b}(i,j−1)=M_{b}(i,j+1)=M_{b}(i−1,i)=M_{b}(i+1,j)=255 (12)
The erosion algorithm is described as follows: when M_{b}(i,j)=0, set the mask of the 4 neighbor points as
M_{b}(i,j−1)=M_{b}(i,j+1)=M_{b}(i−1,j)=M_{b}(i+1,j)=0 (13)
Convoluting the above-mentioned mask and binarized image can eliminate the dilapidation.
Step 6: Next, the lateral mask can be used to obtain the contours of the moving object. Where, the Sobel (the image contour operation mask) is used to obtain the object contours.
Convolute the Sobel (the image contour operation mask) mask and the real-time image, which can be denoted by formula (14) and (15):
Gₓ(x,y)=(NEW(x−1,y+1)+2×NEW(x,y+1)+NEW(x+1,y+1))−(NEW(x−1,y−1)+2×NEW(x,y−1)+NEW(x+1,y−1)) (14)
G_{y}(i,j)=(NEW(x+1,y−1)+2×NEW(x+1,y)+NEW(x+1,y+1))−(NEW(x−1,y−1)+2×NEW(x−1,y)+NEW(x−1,y+1))
The rim of the acquired image can be obtained by using formula (16).
G(x,y)=\sqrt{Gₓ(x,y)²+G_{y}(x,y)²} (16)
Then the above rim image is binarized.
$$E ( x , y ) = \{ \begin{matrix}255 & G ( x , y ) \geq {T}_{e}^{*} \\ 0 & G ( x , y ) < {T}_{e}^{*}\end{matrix} \qquad ( 17 )$$
Wherein Tₑ* represents the optimal threshold, the optimal threshold can be obtained using the prior method; then, after mixing the binarization contour pattern of the real-time image and the differentiated binary image BIN(x,y), the periphery contour of the moving object can be obtained.
Step 7: Check if the contour point coordinates of the moving object is touched by the reactive area and run the corresponding movement.
Step 8: Repeat all the steps above;

2. The said interactive real-time image recognition software method is described as follows:
Step 1: Capture the image projected to the image region by an image projection apparatus as reference images by using video camera;
Step 2: Capture the real-time image continuously projected by an image projection apparatus to the image region by using a video camera, wherein images have active images. Then, check if the reactive area is touched by any foreign object.
The difference value between reference images in step 1 and real-time images in step 2 can be defined by the following formula (1):
DIFF(x,y)=|REF(x,y)−NEW(x,y)| (1)
Step 3: Difference of the grey-level values of said reference image from step 1 with grey-level values of real-time images from step 2 and get the remaining image, which is denoted by formula (2)
$$BIN ( x , y ) = \{ \begin{matrix}255 & DIFF ( x , y ) \geq {T}^{*} \\ 0 & DIFF ( x , y ) < {T}^{*}\end{matrix} \qquad ( 2 )$$
The binarization method removes the effect of noises.
Step 4: After binarization, the white segments refer to the active images and within the images. The active images and can be segmented by using the Line Segment Coding Method, said line segment coding method is a line segment restore method to store every bit of data in an object. Once the segmented images are detected in line 1, it can be regarded as the first line of the first object denoted as 1-1. Then, two lines are detected in the second line. Since the first line is under 1-1 that is denoted as 1-2, the second line is a new object denoted as 2-1. Accordingly, there is only 1 line under object 1 and object 2 in the forth line. Therefore, the image originally regarded as two objects actually is an object, which is denoted as 1-4. After all the images are scanned, then the merge procedure is performed.
Wherein, the information of every object includes: square area, circumference, object characteristic, segmented image size, width and the total number of the object.
Step 5: when the active images and activity reactive area are segmented, every object characteristic value is calculated. Seven unchanged matrixes are used to represent the object characteristics. The solution is described as follows:
The (k+1) matrix definition of a binary image b(m, n) is
$${M}_{k , l} = {\sum }_{m = 0}^{M - 1} {\sum }_{n = 0}^{N - 1} {m}^{k} {n}^{l} b ( m , n ) \qquad ( 18 )$$
Wherein, the center matrix is defined as:
$${μ}_{k , l} = {\sum }_{m = 0}^{M - 1} {\sum }_{n = 0}^{N - 1} {( m - \overline{x} )}^{k} {( n - \overline{y} )}^{l} b ( m , n ) \qquad ( 19 )$$
Wherein,
$$\overline{x} = \frac{{M}_{1 , 0}}{{M}_{0 , 0}} , \overline{y} = \frac{{M}_{0 , 1}}{{M}_{0 , 0}}$$
represents the mass center of the object respectively.
Then the normalized center matrix of the formula (19) is defined as follows:
$${η}_{k , l} = \frac{{μ}_{k , l}}{{( \sqrt{{μ}_{0 , 0}} )}^{k + l + 2}} \qquad ( 20 )$$
The seven unchanged matrixes can be obtained by the normalized second and third order matrix:
$${φ}_{1} = {η}_{2 , 0} + {η}_{0 , 2}$$
$${φ}_{2} = {( {η}_{2 , 0} - {η}_{0 , 2} )}^{2} + 4 {η}_{1 , 1}^{2}$$
$${φ}_{3} = {( {η}_{3 , 0} - 3 {η}_{1 , 2} )}^{2} + {( 3 {η}_{2 , 1} - {η}_{0 , 3} )}^{2}$$
$${φ}_{4} = {( {η}_{3 , 0} + {η}_{1 , 2} )}^{2} + {( {η}_{2 , 1} + {η}_{0 , 3} )}^{2}$$
$$\begin{matrix}{φ}_{5} = ( {η}_{3 , 0} - 3 {η}_{1 , 2} ) ( {η}_{3 , 0} + {η}_{1 , 2} ) [ {( {η}_{3 , 0} + {η}_{1 , 2} )}^{2} - 3 {( {η}_{2 , 1} + {η}_{0 , 3} )}^{2} ] + \\ ( 3 {η}_{2 , 1} - {η}_{0 , 3} ) ( {η}_{2 , 1} + {η}_{0 , 3} ) [ 3 {( {η}_{3 , 0} + {η}_{1 , 2} )}^{2} - {( {η}_{2 , 1} + {η}_{0 , 3} )}^{2} ]\end{matrix}$$
$$\begin{matrix}{φ}_{6} = ( {η}_{2 , 0} - {η}_{0 , 2} ) [ {( {η}_{3 , 0} + {η}_{1 , 2} )}^{2} - {( {η}_{2 , 1} + {η}_{0 , 3} )}^{2} ] + \\ 4 {η}_{1 , 1} ( {η}_{3 , 0} + {η}_{1 , 2} ) ( {η}_{2 , 1} + {η}_{0 , 3} )\end{matrix}$$
$$\begin{matrix}{φ}_{7} = ( 3 {η}_{2 , 1} - {η}_{0 , 3} ) ( {η}_{3 , 0} + {η}_{1 , 2} ) [ {( {η}_{3 , 0} + {η}_{1 , 2} )}^{2} - 3 {( {η}_{2 , 1} + {η}_{0 , 3} )}^{2} ] + \\ ( 3 {η}_{1 , 2} - {η}_{0 , 3} ) ( {η}_{2 , 1} + {η}_{0 , 3} ) [ 3 {( {η}_{3 , 0} + {η}_{1 , 2} )}^{2} - {( {η}_{2 , 1} + {μ}_{0 , 3} )}^{2} ]\end{matrix}$$
Step 6: In the realistic pattern recognition process, the pattern of each category has different characteristic vectors within a range, while the falling point within the range cannot be predicted precisely even the range is known. Such kind of random problem can be described using the probability concept. Here, the Bayesian classifier of Gaussian pattern category is adopted to recognize patterns to be identified in real time, which can be described as:
$${D}_{j} ( x ) = - \frac{1}{2} ln \vert {C}_{j} \vert - \frac{1}{2} [ {( x - {m}_{j} )}^{T} {C}_{j}^{- 1} ( x - {m}_{j} ) ] , \\ j = 1 , 2 Λ M - \qquad ( 21 )$$
Wherein, Dⱼ is the j^{th} pattern decision function; x=[φ₁Aφ₇] is the j^{th} eigenvector; mⱼ and Cⱼ is the j^{th} average eigenvector and covariance matrix. When D is the maximum, it is classified as the j^{th} pattern. After the pattern recognition is completed, the position of the reactive area is decided. The recognition process can be summarized as:
(1). Practice the pattern template in advance, calculate each category φ₁Aφ₇, and calculate mⱼ and Cⱼ of each category, then the decision rules of each categorizer are completed.
(2). Segment the images acquired by video camera 12 into several sub images through step 4, and then calculate each Dⱼ (x) of sub images.
(3) Compare the size of Dⱼ (x), identify the maximum, and set the pattern as the k^{th} category.
After the recognition, the activity reactive area can be located precisely.
Step 7: Check if the activity reactive area is touched by foreign objects and perform the corresponding actions.
Step 8: Repeat all the steps above;

3. This is the same above-mentioned claim 2 of the said interactive real-time image recognition software method, wherein said step 6: if there are several reactive areas in the images, there are several sub reference images. The passive recognition step 1 through 8 is utilized to determine whether the foreign object touches the sub reference images.
